(19) United States
(12) Patent Application Publication
(10) Pub. No.: US 2015/0025971 A1
(43) Pub. Date: Jan. 22, 2015

(54) USER INITIATED PROMOTIONS USING SOCIAL NETWORKS

(71) Applicants: Blake A. Shipley, Cincinnati, OH (US); Troy J. Davis, Norwood, OH (US); Andrew Murray, Cincinnati, OH (US); Kara Loo, Denver, CO (US)

(72) Inventors: Blake A. Shipley, Cincinnati, OH (US); Troy J. Davis, Norwood, OH (US); Andrew Murray, Cincinnati, OH (US); Kara Loo, Denver, CO (US)

(21) Appl. No.: 14/216,145

(22) Filed: Mar. 17, 2014

Related U.S. Application Data
(60) Provisional application No. 61/789,982, filed on Mar. 15, 2013.

(51) Int. Cl. G06Q 30/02; G06Q 50/00

(52) U.S. Cl. CPC G06Q 30/0257; G06Q 50/01
USPC 705/14.55

(57) ABSTRACT

Systems and methods are provided for using social media to petition a company for a promotional offer. A user generates a petition that includes a request for a promotional offer from the company. The user can invite other users to join the petition using social media. The user can post the petition to social media. Other users can join the petition. The company can determine whether to offer the promotional offer based on the number of users that join the petition. The terms of the promotional offer can be based on the level of consumer interest and the number of users that join the petition. The company can offer the promotion using social media.

### REFERENCE TO RELATED APPLICATIONS

This application claims priority to U.S. Provisional Patent Application No. 61/789,982 filed Mar. 15, 2013, which is hereby incorporated herein by reference in its entirety.

### TECHNICAL FIELD

The systems and methods described below relate generally to the field of user initiated promotions that are subsequently offered by companies based upon consumer interest. More particularly, the systems and methods relate to petitioning a company to offer a deal or event, where the petition is generated by a user, invitations to join the petition are distributed to consumers using social media, the petition is joined by other consumers through social media, and the company offers the promotion requested in the petition, such as a discount on a product or entry into an entertainment venue, when there is sufficient consumer interest. The system and method also relate to the field of real-time verification of promotions at the time of redemption, for example at a merchant's point-of-sale terminal, or an entrance to an entertainment venue.

### SUMMARY

In accordance with one embodiment, a computer-based method includes generating a petition by a first user that includes a petition that requests a promotional offer from a company, inviting a second user to join the petition by the first user, joining the petition by the second user, and offering the promotional offer by the company. The company offers the promotional offer using social media and the determination as to whether to offer the promotional offer is based at least in part on the second user joining the petition. In a configuration, the first users invites a plurality of users to join the petition and the determination is based on a threshold number of users joining the petition. The threshold number of users from the plurality of users joining the petition can provide an indication of sufficient consumer interest in the promotional offer.

In accordance with another embodiment, a computer-based method includes generating a petition by a user of a social media website, where the petition includes a request for a promotional offer to be offered from a company. The method further includes posting the petition by the user on the social media website. In a configuration, one or more social media websites are contemplated. The method further include joining the petition by the plurality of users using the social media website, and offering the promotional offer by the company using the social medial website. The company offers the promotional offer at least in part on the number of users who join the petition using the social media website. In a configuration, the terms of the promotional offer are based at least in part on the number of users who join the petition using the social media website.

### BRIEF DESCRIPTION OF THE DRAWINGS

FIG. 1 depicts a block diagram of a system configured to facilitate customer initiated petitions requesting deals and events from companies.

FIG. 2 depicts a block diagram of a real-time offer verification system for verifying the offers and promotions for the deals and events of the system of FIG. 1.

FIG. 3 depicts an example network diagram and computing devices for implementing the system of FIG. 1.

FIG. 4 depicts an example computing device of FIG. 3.

FIG. 5 depicts a flow diagram of the system of FIG. 1.

FIG. 6 depicts a flowchart of the operation of the system of FIG. 1.

FIG. 7 depicts an example email communication.

FIG. 8 depicts an example communication using social media.

FIG. 9 depicts example modules of user functions of the system of FIG. 1.

FIG. 10 depicts example modules of company functions of the system of FIG. 1.

FIG. 11 depicts additional example modules of company functions of the system of FIG. 1.

FIG. 12 depicts example modules of social media functions of the system of FIG. 1.

### DETAILED DESCRIPTION

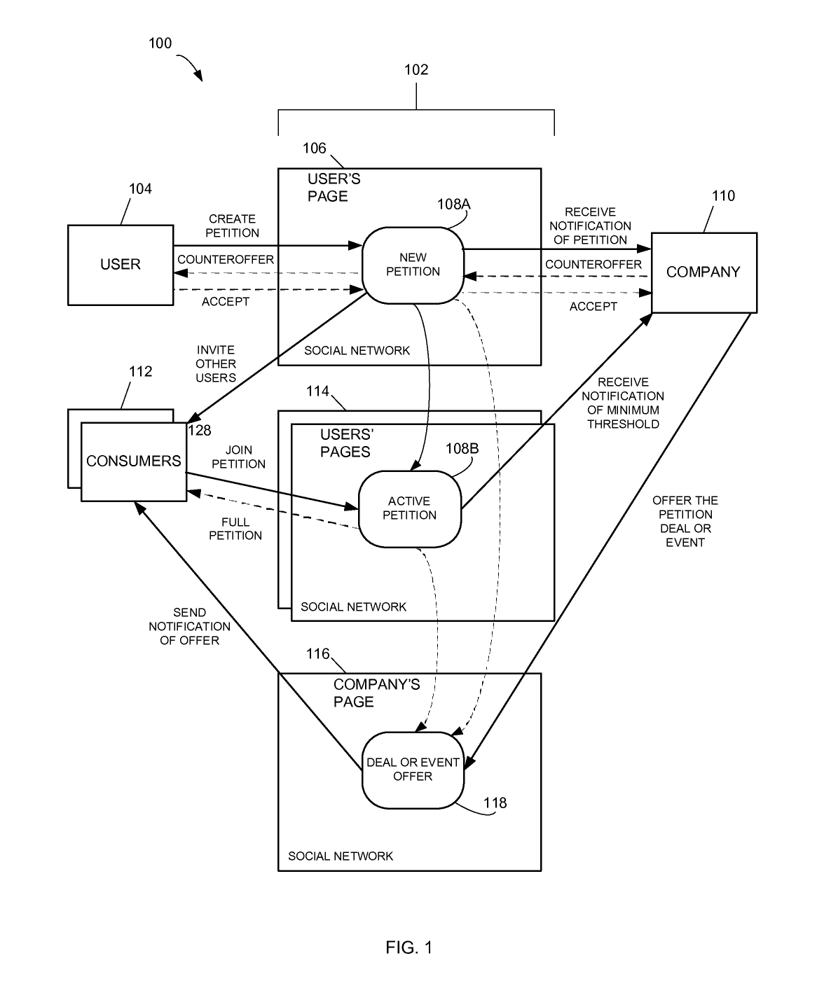

Various non-limiting embodiments of the present disclosure will now be described to provide an overall understanding of the principles of the structure, function, and use of systems and methods disclosed herein for petitioning companies to offer promotions using social networking. One or more examples of these non-limiting embodiments are illustrated in the selected examples disclosed and described in detail with reference made to FIGS. 1-12 in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context. It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

FIG. 1 depicts a block diagram of an example system 100 for petitioning companies to offer promotions using social networking. The system uses one or more social networks 102 or social networking resources. A social network 102 can be graphically represented by a set of interconnected nodes where each node represents a member of the social network 102 and each connection between nodes represents a social connection between members, and social networking is set of communications transmitted between nodes to members.

A user 104 can have a user's page 106 on the social network 102. An example user 104 is a consumer 112, but a user may also be non-consumer, a promoter, or a marketing agent, for example a blogger who promotes the products of the company 110 or the company 110 itself, for example through social media 102. The user 104 can create a new petition 108A to request that a company 110 offer a deal or event, for example a promotional discount for a product that the company 110 offers for sale. For example, a user 104 can create a new petition 108A that requests a company 110 to offer a $1.00 discount to the first five hundred consumers 112, or other users of the social network 102, who join the petition. The promotion can be contingent on the user 104 being able to get at least one hundred consumers 112 to join the user 104 on an active petition 108B. In a configuration, the consumers 112 can be required to “like” a company's page 116 prior to being able to join the active petition 108B or there can be other requirements. In a configuration, the company 110 can create a new petition 108A.

The user 104 can create the new petition 108A by entering information about the deal or event. For example, the new petition 108A can include a petition name, the identity of the company 110, details about the promotion such as a discount to be offered, or if the promotion is an entertainment event, the details can include information about the particular venue and entertainment, for example the name of a band and the seats or tickets to be made available in the promotion. The new petition 108A can include a minimum number of consumers 112 who must join or support an active petition 108B in order for the company 110 to be obligated to offer the deal or event. The new petition 108A can include a maximum number of consumers 112 who can participate in the deal or event. The new petition 108A can include a list of consumers 112 who will initially receive notice of an active petition 108B, for example through a notification using social media 102. The list of consumers 112 can be a list of the only consumer 112 who are eligible to join or support the active petition 108B and receive the promotion. For example, the list of consumers 112 can be members of a particular group, consumers 112 who have entered a contest or “liked” the company's page 116, or other suitable open or closed set of consumers 112. The new petition 108A can also include system 100 specific information, such as the petition status, and any promotions or rewards to be awarded to the user 104 for creating the new petition 108A, reaching a threshold number of consumer 112 who have joined or supported the active petition 108B, or any other suitable threshold for awarding compensation to the user 104. Non-limiting types of promotions and rewards include, but are not limited to, monetary awards, coupons, discount offers, gift cards, contest entries, and so forth.

Once the new petition 108A has been created and saved in the system 100, the system 100 turns the new petition 108A into an active petition 108B. The system 100 can send a notification to the company 110 about the active petition 108B. The company 110 can perform a number of optional actions, such as acknowledging the active petition 108B, accepting the deal or event in the active petition 108B, counteroffering, or rejecting the deal or event in the active petition 108. If the company 110 rejects the active petition 108B, then the active petition 108B will be cancelled and removed. The company 110 can make a counteroffer by changing one or more of the details about the deal or event. The counteroffer can be sent or presented to the user 104 who can similarly acknowledge, accept, counteroffer, or reject the counteroffer of the company 110. This negotiation can continue until the details of the active petition 108B are accepted by the user 104 and company 110.

The system 100 can publish the active petition 108B, for example by posting the active petition 108B on users' pages 114 using social media 102. The posting of the active petition 108B can include information about the active petition 108B and include a link, or other instructions, for joining or supporting the petition. In various configurations, the system 100 can publish the active petition 108B when it becomes active, once the company 110 has accepted the terms of the active petition 108B, once the minimum threshold of consumers 112 have joined or supported the active petition 108B, once the maximum number of consumers 112 has been reached, or other suitable event or threshold crossing has occurred. For example, the system 100 can publish the active petition 108B on users' pages 114 to an initial list of consumers 112 as soon as the new petition 108A has been saved and turned into an active petition 108B, but only publish the active petition 108B on the company's page 116 once the minimum threshold of consumers 112 have joined or supported the active petition 108B.

In a configuration, the system 100 can send notifications to the company 110 when a particular event has occurred or a threshold crossed. For example the system 100 can send a notification to the company 110 when the minimum threshold of consumers 112 have joined the active petition 108B and also send a notification to the company 110 when the maximum number of consumers 112 have joined the active petition 108B. In various configurations, the company 110 or the system 100 can determine when to, and how to, publish or present the active petition 108B to the consumers 112 or promotion information 118 on the company's page 116, or otherwise inform the consumers 112 about the active petition 108B or promotion information 118. For example, the promotion information 118 can include text or graphic, such as would be used for marketing materials. The promotion information 118 can include the active petition 108B, for example to make the promotion available to a larger number of consumers 112, for example to reach the maximum number of consumers 112. The promotion information 118 can include any suitable information, including a printable coupon, a key for activating software, a code for receiving a discount at a register in a store, and so forth. The promotion information 118 can include a link, such as a uniform resource locator (URL) or shortened URL, for consumers 112 to receive a promotional offer, coupon, discount, ticket, and so forth.

The consumers 112 can receive notification about an active petition 108B through social media, for example by email, instant message, or a post to the users' pages 114. The consumers 112 can join the active petition 108B. If the maximum number of consumers 112 has been reached, the consumers 112 can receive a notification that the petition is full. The company 110 or system 100 can similarly notify the consumers 112 about the promotion information 118 through social media, for example by email, instant message, or a post to the users' pages 114. By using social media 102, the system 100, users 104, consumers 112, and companies 110 can easily share active petitions 108B and promotion information 118 with friends, contacts, and others.

Although the system 100 and method presented describes posts to users' pages 114 using a social network 102, other means of sending information to parties and other forms of social media are also considered, such as email messages, a short message service or SMS message, a message from a web log, and can include phone, voicemail, or other audible messages. Web logs are commonly referred to as blogs and can include microblogs and blog messages. Individuals who post information to blogs are colloquially referred to a bloggers.

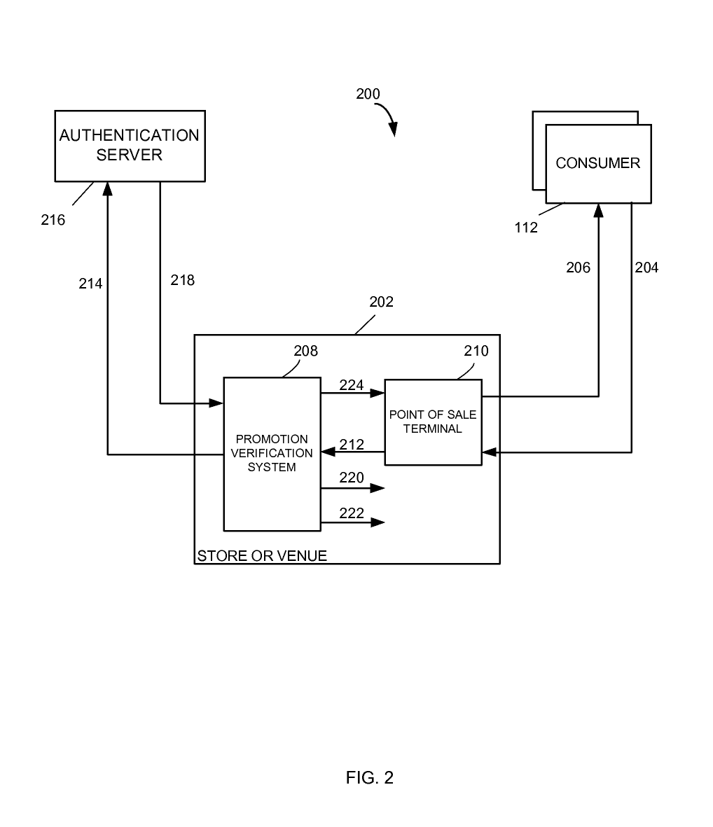

In FIG. 2, a block diagram of an example real-time offer verification system 200 is presented. A consumer 112, for example a consumer of FIG. 1 who has received a coupon 204 as a promotion, presents the coupon 204 at a place of business 202 to receive a discount on a product 206. For example, if the place of business 202 is a store, the consumer 112 can be purchasing the product 206 as shown. Although the following example describes a consumer 112 who is purchasing a product 206 and is using the coupon 204 to receive a discount, the example real-time offer verification system 200 is also applicable to consumers 112 who are receiving a service, obtaining admission to a venue, and so forth.

The consumer 112 can present the coupon 204 to a clerk or a merchant, or the consumer 112 can display the coupon 204 to an automated point-of-sale register 210 at the place of business 202. The coupon 204 can be the entire payment for the product 206, or the coupon can be a discount or other form of promotion or offer. The coupon 204 can be a printed coupon having a code, such as a bar code or QR code. The coupon 204 can also be electronically delivered, for example by a message using wireless communication. In a configuration, the coupon 204 can be displayed on a user's mobile device and scanned by the point-of-sale terminal 210 or a promotion verification system 208.

A promotion verification system 208 allows the place of business 202 to verify and authenticate the coupon 204 to ensure that the coupon 204 is genuine and not, for example, an unauthorized copy, an expired coupon, or a coupon 204 that has already been redeemed. When the consumer 112 presents the coupon 204 to a register clerk for redemption, for example when paying at a point-of-sale terminal 210, the clerk enters 212 the coupon information into the promotion verification system 208, for example by scanning a bar code on the coupon 204 or any other authentication or identifying indicia on the coupon 204. The promotion verification system 208 can perform an authentication request 214 for the coupon with an authentication system 216. The authentication system 216 can be associated with the system 100 or the company 110 of FIG. 1. The authentication system 216 can comprise a database for validating coupons and other promotions, and a web server for accepting the authentication requests 214 and sending back authentication answers 218 to the promotion verification system 208. The authentication system 216 can send an authentication answer 218 back to the promotion verification system 208 to indicate whether or not the coupon 204 is authentic, has not-expired, and has not been previously redeemed by the consumer 112. In addition, the promotion verification system 208 or the merchant or place of business 202 can perform further verification as to whether or not the consumer 112 presenting the coupon 204 has met all of the requirements for the coupon 204 or promotion. For example, the coupon 204 might be valid only for a particular consumer 112, and therefore the place of business 202 can check the identity of the consumer 112 on a driver's license, or other formal identification, to verify the identity of the consumer 112.

If the promotion verification system 208 indicates that the coupon 204 is valid, the promotion verification system 208 can flash a green light 220, or provide any other suitable type of notification, to indicate that the coupon is valid, thereby providing a visual indication to a clerk to apply 224 the coupon 204 to the current purchase 206 at the point-of-sale terminal 210. The consumer 112 receives the products 706 or services at the discounted price. If the promotion verification system 208 indicates that the coupon 204 is invalid, the promotion verification system 208 can flash a red light 222, or provide any other suitable type of notification, to indicate that the coupon 204 has not been accepted. By flashing a red light 222, the consumer 112 can be provided a visual indication that their coupon 204 will not be accepted by the merchant or place of business 202. In a configuration, the point-of-sale terminal 210 and the promotion verification system 208 can be connected via a network connection or communications link so that the coupon 204 can be directly applied 224 by the point-of-sale terminal 210 to the current purchase 206 of the consumer 112.

In a configuration, the promotion verification system 208 can provide any number of suitable indicator lights during the validation and authentication of the coupon 204, or provide printed receipts or tickets. For example, the promotion verification system 208 can provide a first indicator light to indicate when the authentication request 214 has been sent, a second indicator light to indicate the receipt and status of the authentication answer 218, a third indicator light to indicate the status of any further verification operations, a fourth indicator light to indicate that the coupon 204 is valid and accepted, and a fifth indicator light to indicate that the coupon 204 has been successfully applied to the purchase 206 at the point-of-sale terminal 210. Other indications are also considered.

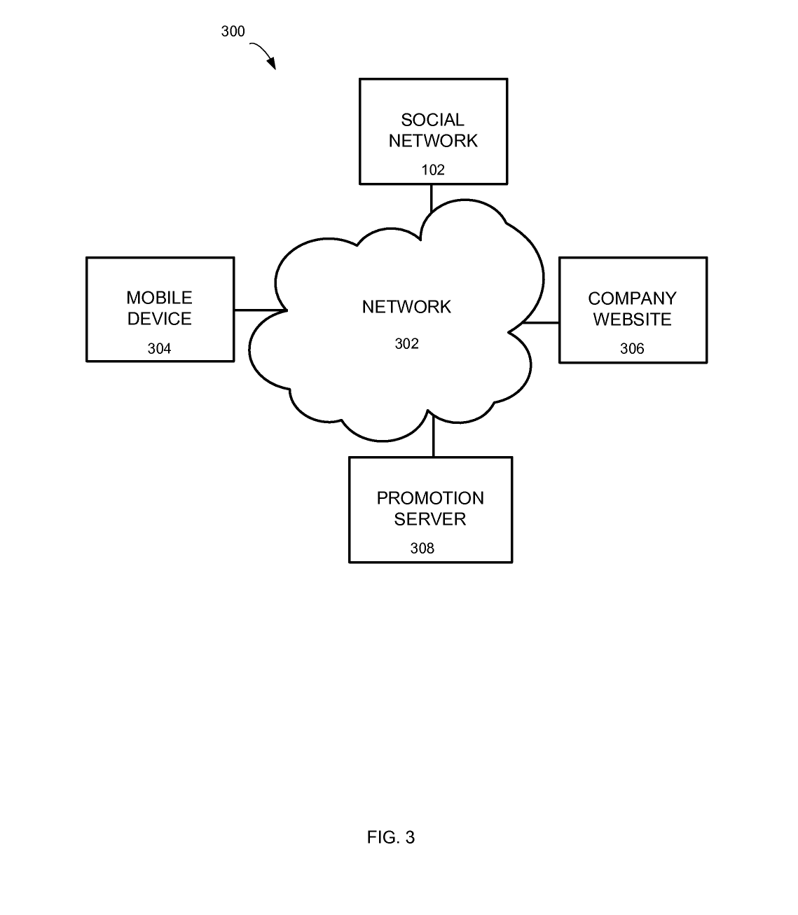

Referring now to FIG. 3, a diagram of an exemplary system 300 for enabling consumer initiated promotions using social networks 102. In the system 300, a computing device 304 associated with a user 104 or consumer 112 of FIG. 1 can run an application for communicating with a social network 102, a company website 306 of a company 110, or a promotion server 308 associated with the system 100 of FIG. 1. An example application is a web browser. In a configuration, computing device 304 is a mobile computing device, such as a cell phone, smart phone, tablet, laptop, or other suitable computing platform having wireless connectivity to a network 302. In a configuration, the application can be an app that is available from the Apple™ iStore™, or another app store, for downloading onto and executing on an Apple™ iPhone™ or iPad™. The computing device 304 also can be a desktop system, a laptop, a tablet, a smartphone, or another suitable computing platform, whether mobile or non-mobile. The network 302 can be any suitable wired or wireless network, or a combination of both, whether private or public, and including, but not limited to, the Internet and telephony based networks. The social network 102, company website 306, and the promotion server 308 can be servers that are computing devices. In the system 300, the user or consumer executes an application on their computing device 304 to communicate with the social network 102, promotion server 308, or company website 306 and create petitions, join active petitions, and receive promotions as described herein.

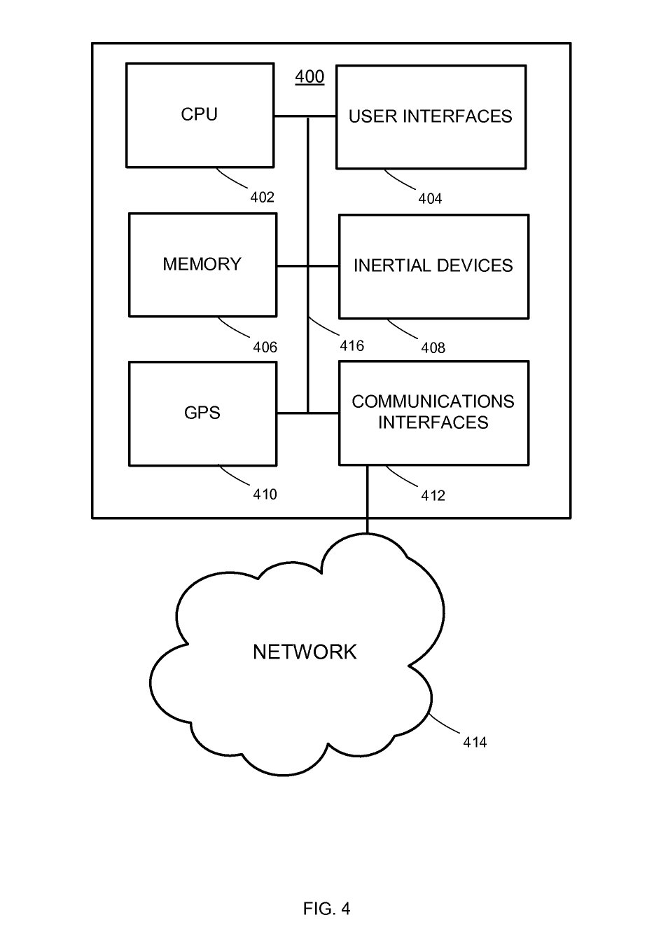

The processes described herein can be executed by programmable equipment, such as computers or computer systems and/or processors. Software that can cause programmable equipment to execute processes can be stored in any storage device. Referring now to FIG. 4, example elements of an exemplary computing device 400 are illustrated. A computing device 400 can be a mobile computing device, a computing device that is integrated with other systems or subsystem, a server, and so forth. The computing device 400 can be any suitable computing device as would be understood in the art, including without limitation, a custom chip, an embedded processing device, a tablet computing device, a personal data assistant (PDA), a wireless e-mail device, an e-ink reading device, a cellular phone, a pager, fax machine, a scanner, a desktop, a laptop, a microcomputer, a minicomputer, a server, a mainframe, or any other suitable programmable device. In various embodiments disclosed herein, a single component can be replaced by multiple components and multiple components can be replaced by a single component to perform a given function or functions. Except where such substitution would not be operative, such substitution is within the intended scope of the embodiments.

The computing device 400 includes a processor 402 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 400 also includes one or more memories 406, for example read only memory (ROM), random access memory (RAM), cache memory associated with the processor 402, or other memories such as dynamic RAM (DRAM), static ram (SRAM), programmable ROM (PROM), electrically erasable PROM (EEPROM), flash memory, a removable memory card or disk, a solid state drive, and so forth. The computing device 400 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media such as flash drives, solid state hard drives, redundant array of individual disks (RAID), virtual drives, networked drives and other memory means including storage media on the processor 402, or memories 406 are also contemplated as storage devices. It can be appreciated that such memory can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

Network and communication interfaces 412 can be configured to transmit to, or receive data from, other computing devices 400 across a network 414. The network and communication interfaces 412 can be an Ethernet interface, a radio interface, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 412 can include wired data transmission links such as Ethernet and TCP/IP. The communication interfaces 412 can include wireless protocols for interfacing with private or public networks 414. For example, the network and communication interfaces 412 and protocols can include interfaces for communicating with private wireless networks such as a WiFi network, one of the IEEE 802.11x family of networks, or another suitable wireless network. The network and communication interfaces 412 can include interfaces and protocols for communicating with public wireless networks 412, using for example wireless protocols used by cellular network providers, including Code Division Multiple Access (CDMA) and Global System for Mobile Communications (GSM). A computing device 400 can use network and communication interfaces 512 to communicate with hardware modules such as a database or data store, or one or more servers or other networked computing resources. Data can be encrypted or protected from unauthorized access.

In various configurations, the computing device 400 can include a system bus 416 for interconnecting the various components of the computing device 400, or the computing device 400 can be integrated into one or more chips such as programmable logic device or application specific integrated circuit (ASIC). The system bus 416 can include a memory controller, a local bus, or a peripheral bus for supporting input and output devices 404, inertial devices 408, GPS and inertial devices 410, and communication interfaces 412. Example input and output devices 404 include keyboards, keypads, gesture or graphical input devices, motion input devices, touchscreen interfaces, one or more displays, audio units, voice recognition units, vibratory devices, computer mice, and any other suitable user interface. An example GPS device 410 can include a GPS receiver and associated circuitry. Inertial devices 408 can include accelerometers and associated circuitry. The associated circuitry can include additional processors 402 and memories 406 as appropriate.

The processor 402 and memory 406 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

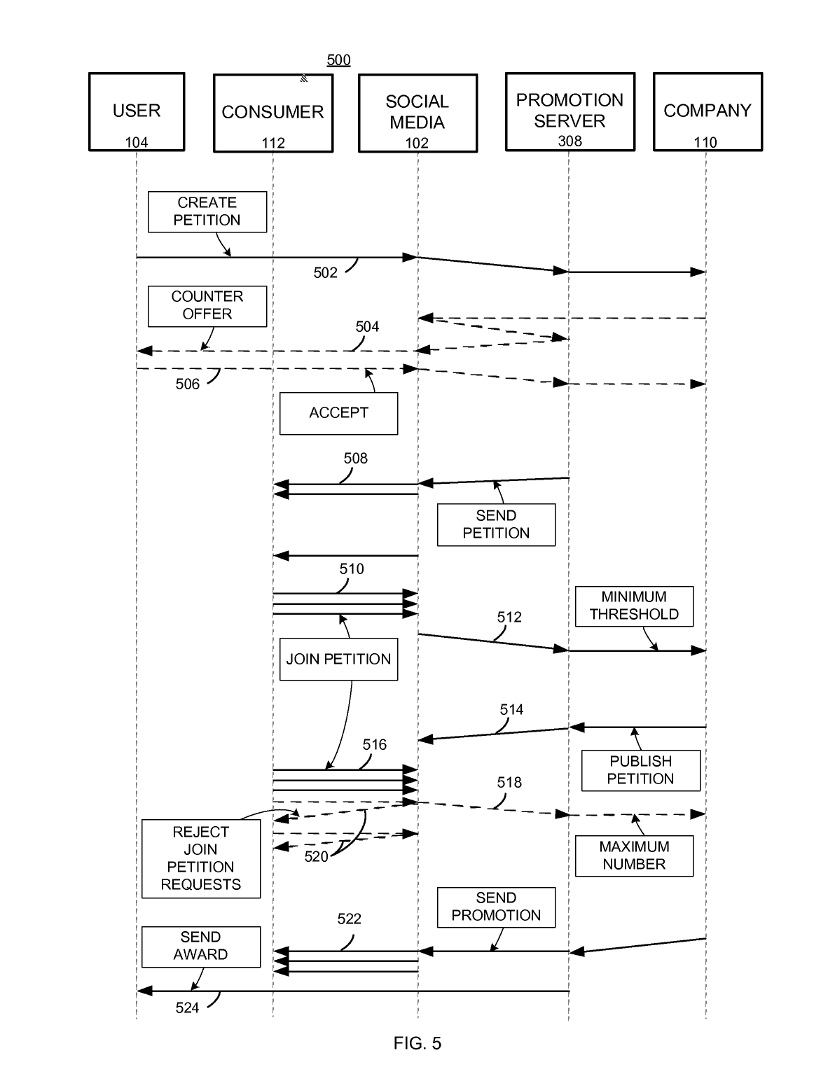

Referring now to FIG. 5, an example flow diagram 500 of the system 100 of FIG. 1 is depicted. As described above with reference to FIGS. 1 and 3, and as shown by line 502, a user 104 creates a petition on a social media 102 website, the social media 102 website forwards the petition to a promotion server 308, and the promotion server 308 forwards the petition to the company 306. In a configuration, the social media 102 website can forward the petition to the company 110 directly.

As shown by line 504, the company 110 can optionally make a counteroffer to the petition on the social media 102 website, the social media 102 website forwards the counteroffer to the promotion server 308, and the promotion server 308 sends the counteroffer to the user 104 using the social media 102 website. The company 110 can, in similar fashion, acknowledge the petition, reject the petition, or accept the petition (not shown). As shown by line 506, the user 104 can accept the terms of the counteroffer on the social media 102 website, and the social media 102 website can forward the acceptance to the promotion server 308 and the promotion server can forward the petition to the company 110. The user 104 can, in similar fashion, make a counteroffer to the counteroffer, or reject the counteroffer (not shown).

At any suitable time after the promotion server 308 receives the petition shown by line 502, including before the optional counteroffer and acceptance shown by lines 504 and 506, the promotion server 308 can send the petition to the social media 102 website and the social media 102 website can send the petition to multiple consumers 112, as shown for lines 508. The consumers 112 can join or support the petition on the social media 102 website as shown by lines 510. For example, the consumers 112 can click a button on the social media 102 website, or perform a series of appropriate actions to join the petition. A consumer 112 can also ignore the petition, or specifically not join the petition (now shown).

Once the minimum threshold of consumers 110 have joined the petition, the social media 102 website can send a notification to the promotion server 308, and the promotion server 308 can send a notification to the company 110, as shown in line 512. After the company 110 has received a notification that the minimum threshold of consumers 112 has been met, or crossed, the company can publish the petition, as shown by line 514. For example, the company 110 can send the promotion server 308 text and graphics to be displayed on the company's page on the social media 102 website, and the promotion server 308 can send the text and graphics, in addition to the petition, to the social media 102 website to be displayed on the company's page.

As a result of the petition being display on the company's page on the social media 102 website, additional consumers 112 may join the petition, as shown by lines 516. If the maximum number of consumers join the petition, the social media 102 website can send a notification to the promotion server 308 and the promotion server can send a notification to the company 110 as shown by line 518. In addition, the social media 102 website can reject further attempts to join the petition by consumers, as shown by lines 520.

At any suitable time after the minimum number of consumer 112 have joined the petition, the company can send a promotion associated with the terms of the petition to the promotion server 308, along with text, graphics, and instructions for obtaining the promotion, and the promotion server 308 can send the promotion, along with the text, graphics, and instructions to the social media 102 website for distribution to the consumers 112 as shown by line 522. The promotion server 308 can send an award to the user 104 who created the petition as shown by line 524.

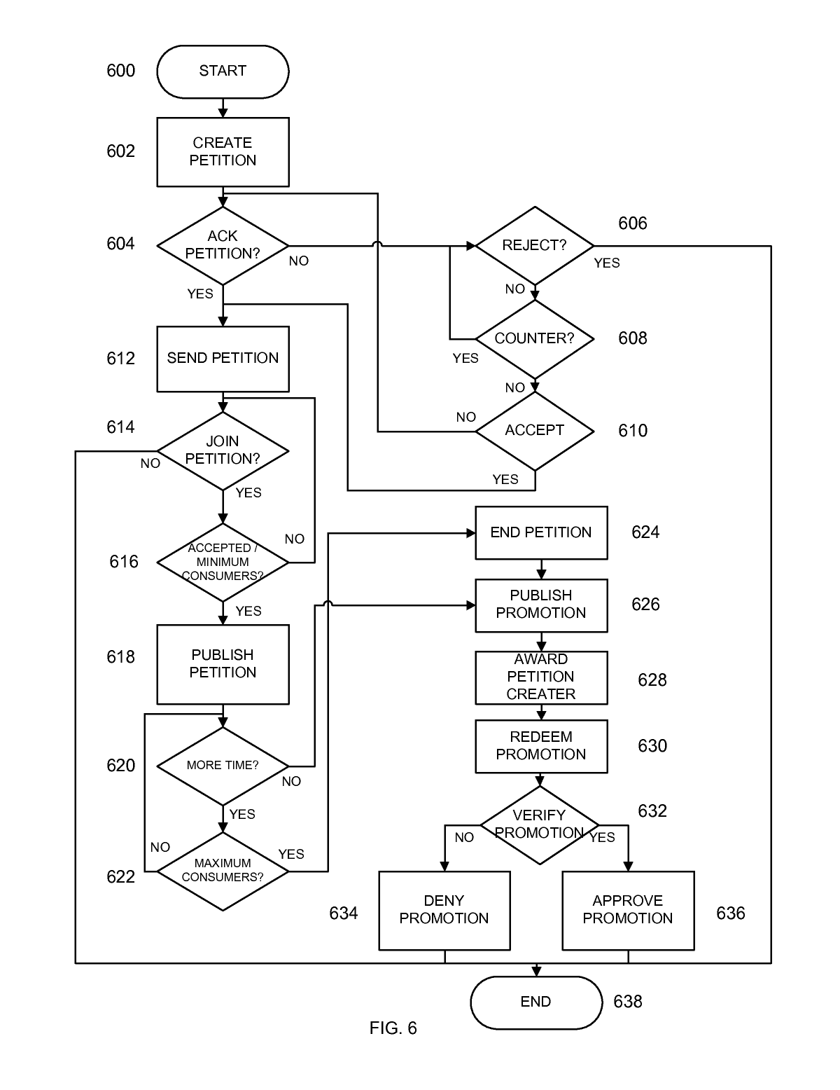

Referring now to FIG. 6, a flowchart of an example operation of the system of FIGS. 1, 2, 3, and 5 is depicted. Operation starts at block 600 labeled START. Operation continues to process block 602 where a user creates a petition as described herein. Operation continues to decision block 604.

In decision block 604, if a company acknowledges, without accepting, the petition, then processing continues to process block 612. Otherwise, processing continues to decision block 606.

In decision block 606, if the petition is rejected, then processing terminates at end block 638 labeled END. For example, if the company rejects the user's petition without counteroffering, or if the user rejects a counteroffer from the company, then processing terminates. Otherwise, processing continues to decision block 608.

In decision block 608, if a counteroffer is made, for example by the company or the user changing the terms of the petition, then processing returns to decision block 606. If a counteroffer is not made, then processing continues at decision block 610.

In decision block 610, if the offer is accepted, for example if the company accepts the petition, or if the user accepts a counteroffer by the company, the processing continues to process block 612. Otherwise, processing continues to decision block 604.

In process block 612, the petition is distributed to consumers, for example the petition can be posted to consumer's pages on a social media website, or the petition can be sent directly to consumers, for example by email or other social media. The petition can be sent by other consumers who received the petition and shared it. In a configuration, consumers who previously “liked” the company's page, or purchased a gift card or product can be added to the email distribution list. Processing continues to decision block 614.

In decision block 614, if a consumer receives a petition but does not join the petition, then processing continues to process block 638 for that consumer. Similarly, if an insufficient number of consumers join the petition within a threshold period of time, then processing continues to end block 638. For example, if the promotion is an event, and if a sufficient number of consumers have not joined the petition prior to the event, then the petition can be terminated by the system. To join the petition, the consumer may have to perform the operation of clicking a button to join, or follow a URL link. In a configuration, the consumer may have to take additional steps in order to activate the join button, or be provided the URL link. For example, the consumer may have to first “Like” a fan page associated with the company, join a particular user group, or share the petition before the user can be eligible to join or support the petition. If a consumer joins the petition, then processing continues to decision block 616.

In decision block 616, if the petition has been accepted by the company, and the minimum number of consumers have joined or supported the petition, then processing continues to process block 618. Otherwise, processing continues to decision block 614 to await the decision to join by additional consumers.

In process block 618, the petition can be published to the company's page on the social network. By publishing the petition to the company's page, additional consumers can be allowed to join the petition and receive the promotion. Processing continues to decision block 620.

In decision block 620, if there is additional time for consumers to join the petition, the processing continues to decision block 622, otherwise, processing continues to process block 626 to publish the promotion.

In decision block 622, if the maximum number of consumers who can join the petition has not been met or crossed, then processing continues back to decision block 620 to determine if there is additional time for consumers to join the petition. If the maximum number of consumer who can join the petition has been met or crossed, then processing continues to process block 624 to end the time period for joining the petition.

In process block 624, because the maximum number of consumers who can join the petition has been met or crossed, the system does not allow additional consumers to join the petition and receive the promotion. Processing continues to process block 626.

In process block 626, the promotion described in the details of the petition is published to the company's page on the social media 102 website. The consumers who joined the petition can be alerted to the presence of the promotion on the company's page on the social media 102 website, for example by receiving a post to their users' pages or by receiving an email. In a configuration, a communication with details about how to redeem the promotion can be send to consumers who joined the petition using social media. The promotion can be displayed by any marketing means, including but not limited to an email, an SMS or text message, a URL, a blog or blog message, a message within the social network, a post within the social network, a fan page within the social network, a picture, an advertisement such as a newsprint advertisement, an in-store advertisement, or an advertisement of any kind. Processing continues to process block 628.

In process block 628, the system can award the user the user who created the petition with points, promotions, or other suitable compensation. The award can be based at least in part on the number of consumers who joined the petition, or the number of consumers to redeem the promotion, or any other suitable factor or factors. The award can be any suitable kind of coupon, discount, offer, gift card, contest entry, reward, financial compensation, or other promotion. Processing continues to process block 630.

In process block 630, the consumers who joined the petition can redeem the promotion. For example, the consumers can follow a link on the company's page related to the promotion to redeem a code, coupon, discount, gift card, contest entry, admission ticket, or other suitable promotion. The consumers can claim a promotion without the promotion being displayed on their computing device, for example a consumer can be provided with an individualized URL or a coded text string to activate the promotion. In a configuration, the promotion can be activated using a mobile computing device by providing the consumer with a quick response code or QR code that can be scanned from the screen of a mobile computing device of the consumer, a bar code, or similar technology. Processing continues to decision block 632.

In decision block 632, if the consumer attempts to use the promotion, the system can verify that the promotion is a valid, not already used, promotion as described herein. If the promotion is not valid, the processing continues to process block 634 to deny the promotion proffered by the consumer. If the promotion is valid, the processing continues to process block 636 to approve the promotion.

In process block 634, the promotion is not valid and is denied. Processing terminates at end block 638.

In process block 636, the promotion is valid and the consumer is award the promotion, discount, product, or entry into the entertainment venue as appropriate to the promotion.

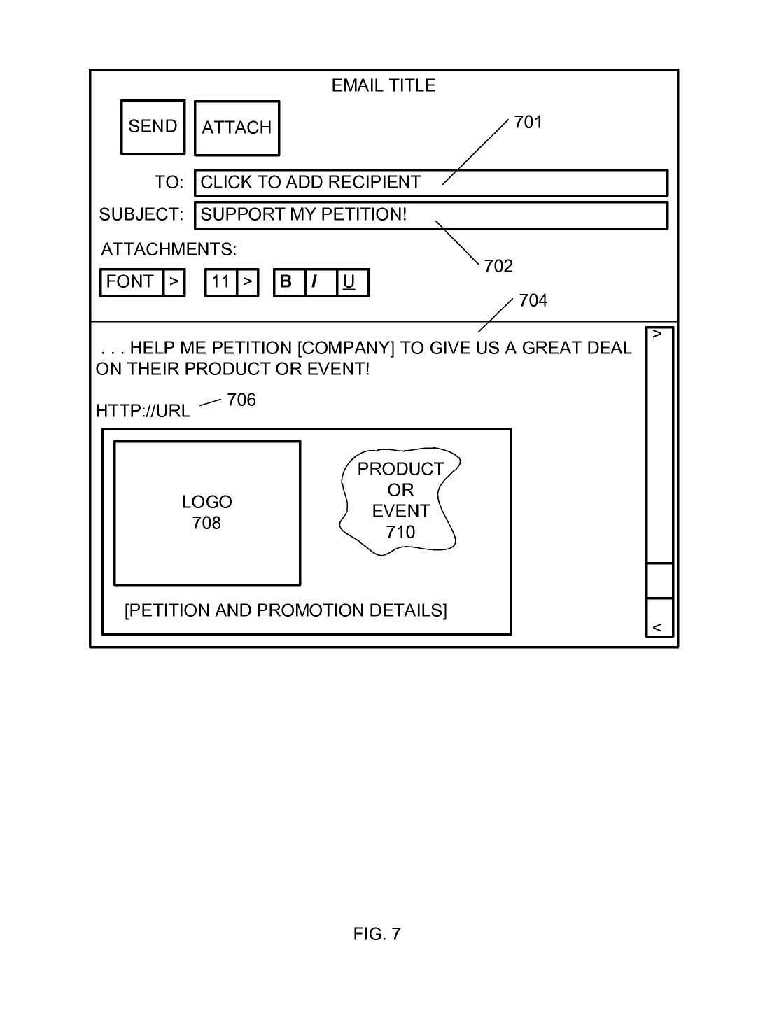

Referring now to FIG. 7, an example email communication 700 is presented. In the example email communication 700 the system, the user 104, or the promotion server 308 (of FIGS. 1 and 3) can send email to consumers to join a petition to request a promotion from a company. The email communication can have an address line 701 addressed to individual consumers or mailing lists, a configurable subject line 701 to interest the recipient of the email, and a message body 704 with a description of the petition. The email communication 700 can include a logo 708 of the company as well as a representation 710, such as a picture or label, of the product or event for the promotion associated with the petition. The email communication can include a uniform resource location, or URL 706, to link the consumer to a site, for example a social media 102 website, the promotion server 308, or the company website 306 as appropriate. The URL 706 can be a shortened URL. The systems and methods presented are also applicable to other forms of social media including, but not limited to email, SMS messages, blogs and blog messages, and any other visual, audio, or multimedia type of messaging.

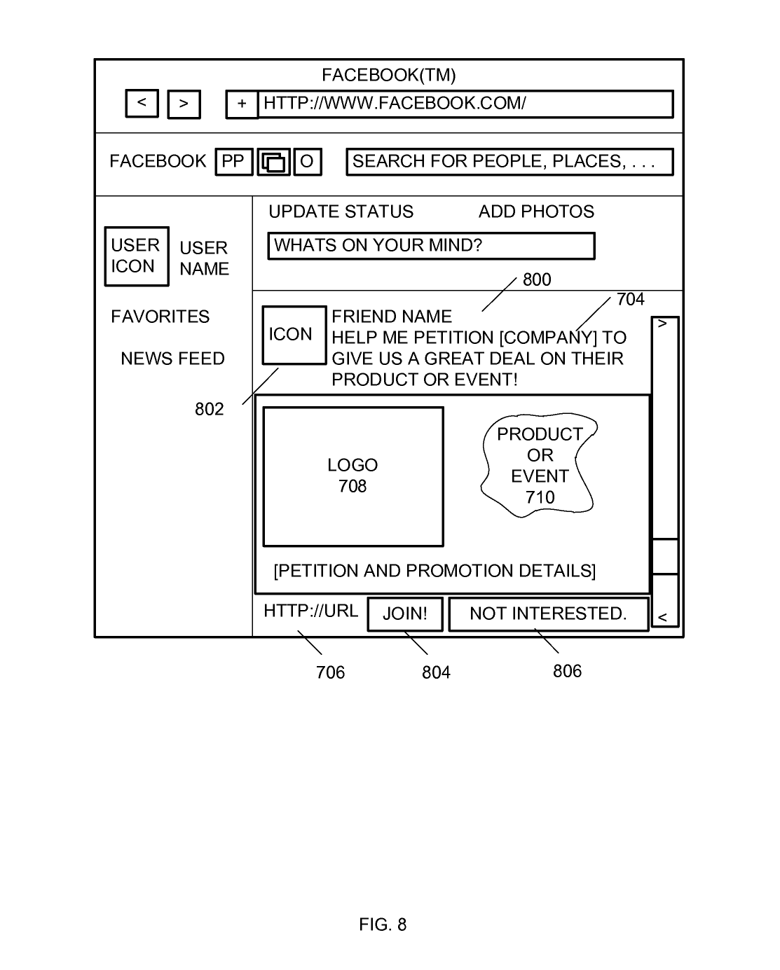

Referring now to FIG. 8, an example social website post 800 is presented. The social website post 800 can contain similar information to the email of FIG. 7, for example a message body 704, a URL 706, a logo 708, and a representation 710 of the product or event. Additionally, the social website post 800 can include an icon 802 that identifies the sender of the post, and selection buttons 804, 806. The consumer can select the join button 804 to join the petition, the not interested button 806 to explicitly reject joining the petition, or the consumer can choose not to respond, for example to respond at a later time.

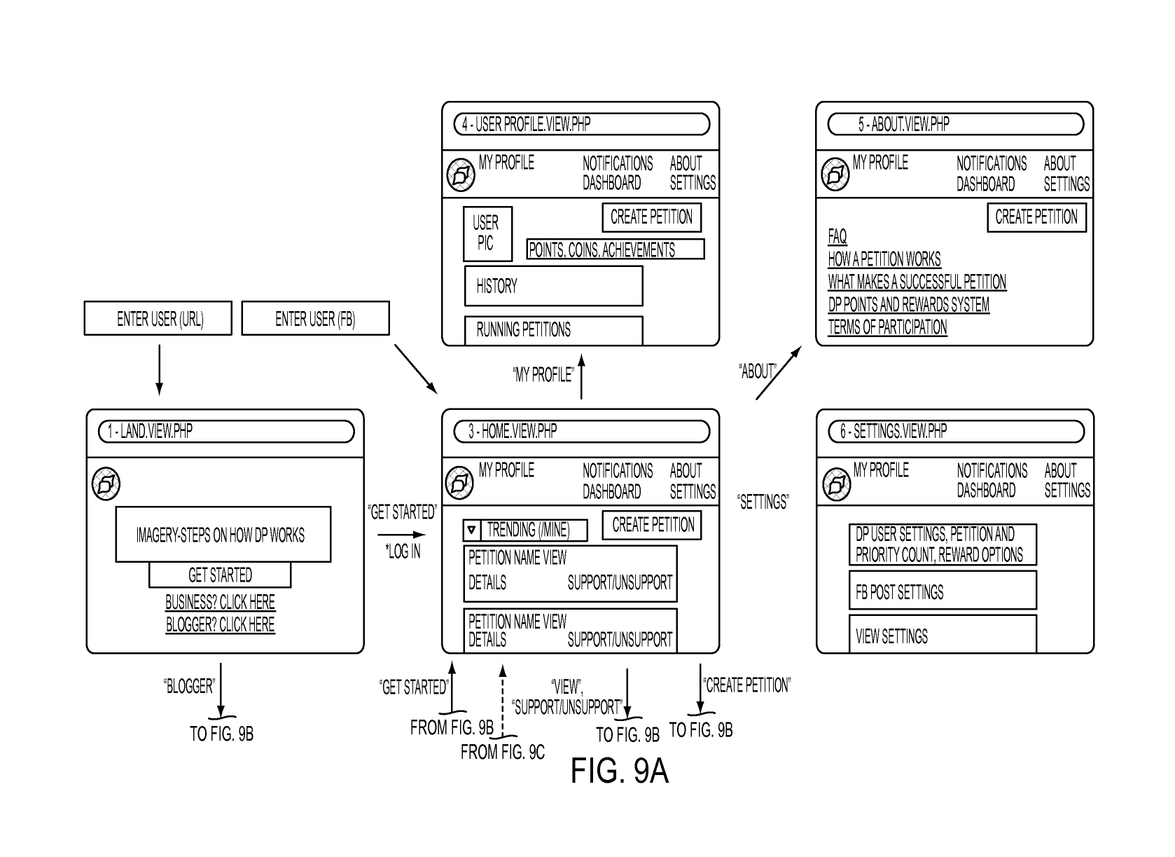

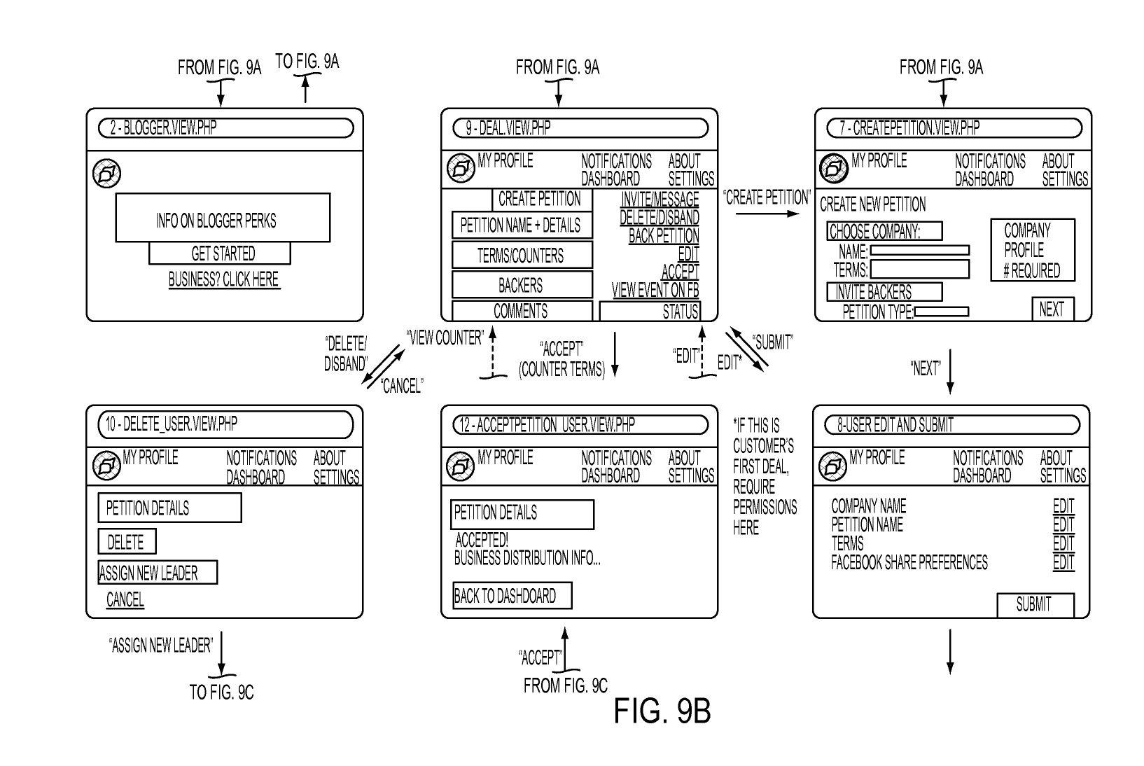

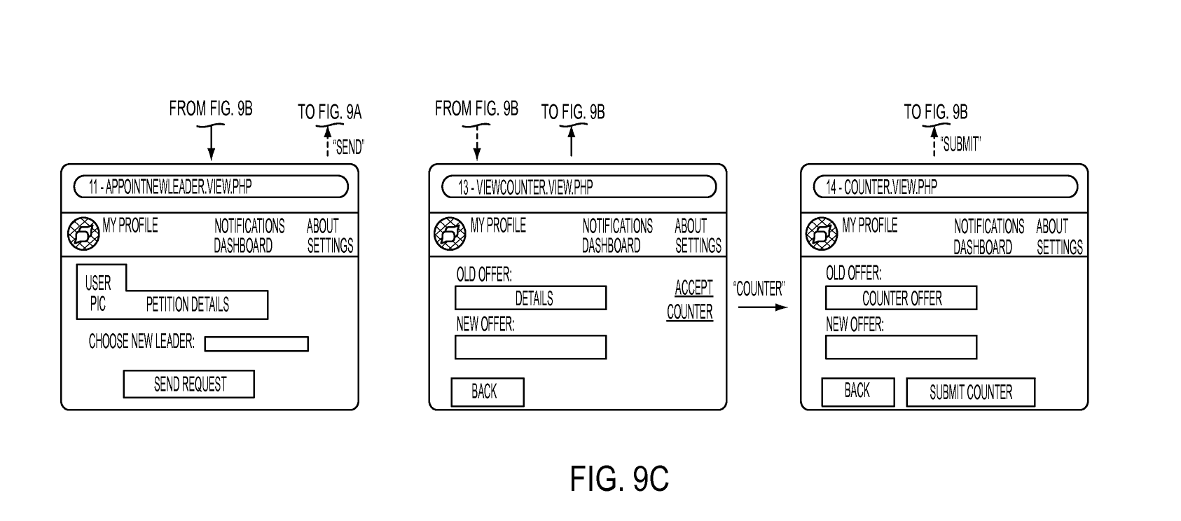

Referring now to FIGS. 9-12, example modules are depicted. The modules are provided to illustrate an example way that a system 100 can be created, and are not intended to limit the disclosure to a particular embodiment. Referring to FIG. 9, example user specific modules for illustrating functions associated with the user interfaces are provided.

In a first embodiment, a user can execute an application such as a browser and enter, or select, a URL to access the system. In the module labeled 1, the user enters the site via URL, and is introduced to the site on the landing page. The user is presented with an explanation of the Deal Petition (DP) process with three simple illustrated steps and a link below inviting them to get started. In addition, links are provided for companies (for routing the user to a company connect page) and bloggers. In module 2, if a user clicks the link for information on a blogger account, they are taken to a page detailing the perks of a Deal Petition blogger account. A link is provided in order to contact Deal Petition and configure the user account as a blogger. A button prompting the user to “get started” is provided, as is an alternate link for the company connect page.

In a second embodiment, the user can execute a social network application, for example by accessing a social network website such as Facebook™ using a browser, or through a dedicated application, for example an app on a mobile computing device. In module 3, if a user clicks on the “get started” link, the user is prompted to log in via a social network, and the user is presented with a page of trending petitions on a limited dashboard page (a full dashboard access is available when a user logs in to DP site using a social network website such as Facebook™; a user may opt out of doing this, but first logs in to take an action on a petition). The dashboard is a hub for all Deal Petition activity and organization of petitions. Users can filter petitions by “trending”, or view only the petitions that they are involved in by selecting “mine”. The user can create a petition using the “create petition” button. Each petition listed on the dashboard displays a variety of information that can include the parties involved, the petition name, the petition details, the number of current supporters or consumers, the minimum and maximum number of consumers required, petition status, and any awards possible for creating a petition. Links to “view” or “support/unsupport” the petition are also provided per petition. The user can click “support” or “unsupport” on the petition on the dashboard view, and this will take them to the petition page. In a configuration of the system, “supporting” or “unsupporting” a petition has the same effect as clicking “view” on a petition; and a user can make a decision regarding a petition on the “global petition page” as described below. Users can also view types of DP information, accessible from the global top menu bar. The informational pages include “my profile”, “about” and “settings”.

In module 4, if a user has logged in, a user has access to their profile via the “my profile” link, which shows the user's history, current petitions (created and supporting), and the rewards and achievements they have gained from Deal Petition. The “create petition” link is also available from the user profile.

In module 5, a user “about” page gives a small intro blurb about the Deal Petition website and process. It also contains FAQ links and helpful resources in order to get started and continue functioning as an active user within the site. The “create petition” link is also available from the “about” page.

In module 6, a user can access a “settings” page where the user can manage account settings. A box at the top can be provided for viewing the user's maximum petition allotment and user levels. The user can view the privileges the user is eligible for and purchase different privileges using petition tokens the user has earned. The second box displays the user's settings for Deal Petition notifications on social networking websites. A third box shows the user's account settings, for example visual customizable settings.

In module 7, if a user clicks the “create petition” button, the user will be directed to a petition creation page, where the user can choose a company to petition, preview that company's data (number of fans on one or more social networking websites, the relative min/max number of supporters required, company history with Deal Petition, etc.), provide a name for the petition and the deal terms, and choose which friends and contacts they will share the petition with. The user can also choose the specific type of petition, either a “deal” or an “event”.

In module 8, the user can access an “edit/publish” page for petitions, and review all details of that petition and publish any changes. Upon hitting the publish button, a first-time user can be required to grant the application certain permissions. The edit page can be the same page that a user returns to at any point in the petition's life in order to edit the petition (in a configuration, the company is not changeable once the petition has been created, and the terms can be changed through the deal's “counter” option). When the next button on the petition's “edit/publish” page is clicked for the first time, the petition page is created. The company to be petitioned is sent a notification. The notification can be email. In the notification, the company can choose to reject the deal, which can effectively shut the deal down, or the company can edit the min/max number of supporters (for example, consumers) necessary for the deal to be accepted by the company.

In module 9, a global petition page for a deal is an accessible page with a unique link that can be made viewable by all members of Deal Petition. If the petition is for an event, the petition page can be made exclusive to a certain group of intended event attendees. Petition pages can show all relevant information related to a petition, which can be dependent on that petition's stage and the account status of the viewer (for example, in this example, the status is “user”). On the petition page, the user can make a decision to support or unsupport the petition via the designated link. The user can also create a new petition from a global petition page. A newly created petition page can be limited, for example until a threshold number of supporters is met or crossed. In a configuration, the threshold can be based at least in part on the number of fans the petitioned company has, or the number of “likes” the company has received, on one or more social networking websites. When the petition becomes supported by a minimum threshold number of users, the petition becomes a “filled petition”. The supporters can be notified, and the petition can be posted on the social media website, for example on the user's page, pages of other users or consumers, or the company's page. The petition creator (user), generally controls the remaining stages of the of a petition from this page. Parties affiliated with the petition can invite supporters or publish comments on the petition page. The user can edit the petition which can route the user back to the petition's edit/publish page. Supporters and companies affiliated with this deal can be notified when a deal has been edited. Counters to the petition's terms made by a company can be viewed on the petition page under the original terms. Supporters can be viewed in a section that can be located in proximity to terms section. A user can choose to accept the petition's counter terms (in which case the petition's supporters can receive a notification) or make a counter offer with different terms. A user who creates a petition and a company being petitioned may go back and forth on petition terms for as many rounds as necessary. If the petition is an event, the user can also choose to view the event page on a social networking website.

In module 10, a user who creates the petition is a petition leader and can delete a petition or step down from petition leadership on the delete page. The user who created the petition can nominate and appoint a new petition leader. If a new position leader is not appointed, default rules can be applied, for example the system will accept the petition's last counter, or delete the petition if there are only original terms. Petition supporters can be notified if a petition is deleted or a new leader is appointed.

In module 11, a user who is a petition leader can appoint a new leader upon stepping down from the “choose new leader” page. The leader the user appoints can receive a notification and generally must agree to become the new petition leader. The newly appointed leader can receive point rewards for taking over the petition and can be responsible for carrying the petition through to its end.

In module 12, if a petition leader decides to accept counter terms from a company, that user can be directed to the “accept petition” page. On the “accept petition” page, the user can be given the details on how and when a company is required to distribute a deal or create an event. If the petition was for a deal, the user can watch for the notification that the deal has been published, after which the deal can be redeemed. At this point, the petition leader can awarded, for example by providing the petition leader with tokens and experience points used to advance reputation and capability in the system. In a configuration, the user and the supporters can wait several days, for example seven days, for the distribution of the deal or creation of the event.

In module 13, if a user wants to view a counter offer made on their petition by a company, the user can click to view the counter offer and can be directed to the “view counter offer page”. At the “view counter offer page”, the user can review the counter terms and choose to accept the counter terms. The user can also provide a counteroffer with new or modified terms.

In module 14, if a user counters a company's counter terms, the user can be directed to a counter revision page. On the counter revision page, the counter offer can be revised. The user can click the “submit” button when ready. The new, revised terms will show up below the company's counter on the petition page. The company will be notified of the new counter terms, for example by email notification.

A user can access basic functions, such as viewing and supporting deals through social media websites. In a configuration, the user can be required to use a browser and navigate to the appropriate URL in order to review or modify the user's profile information and settings, or to create and manage a petition.

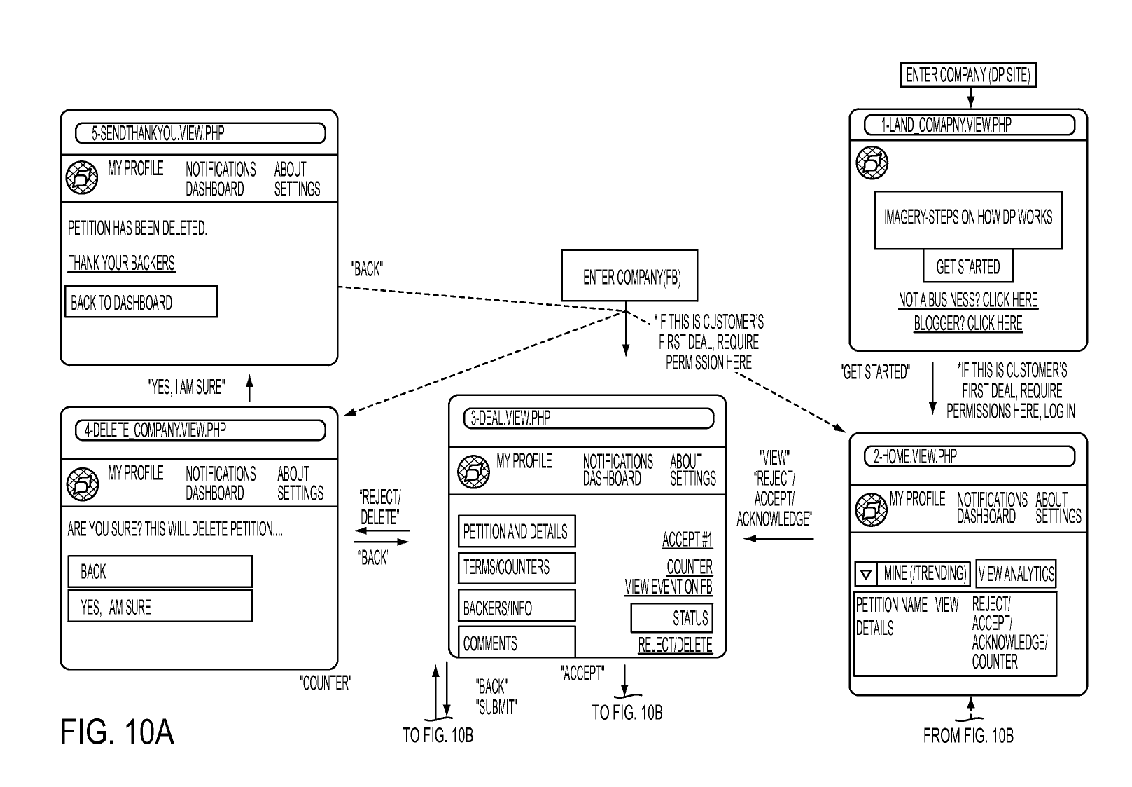

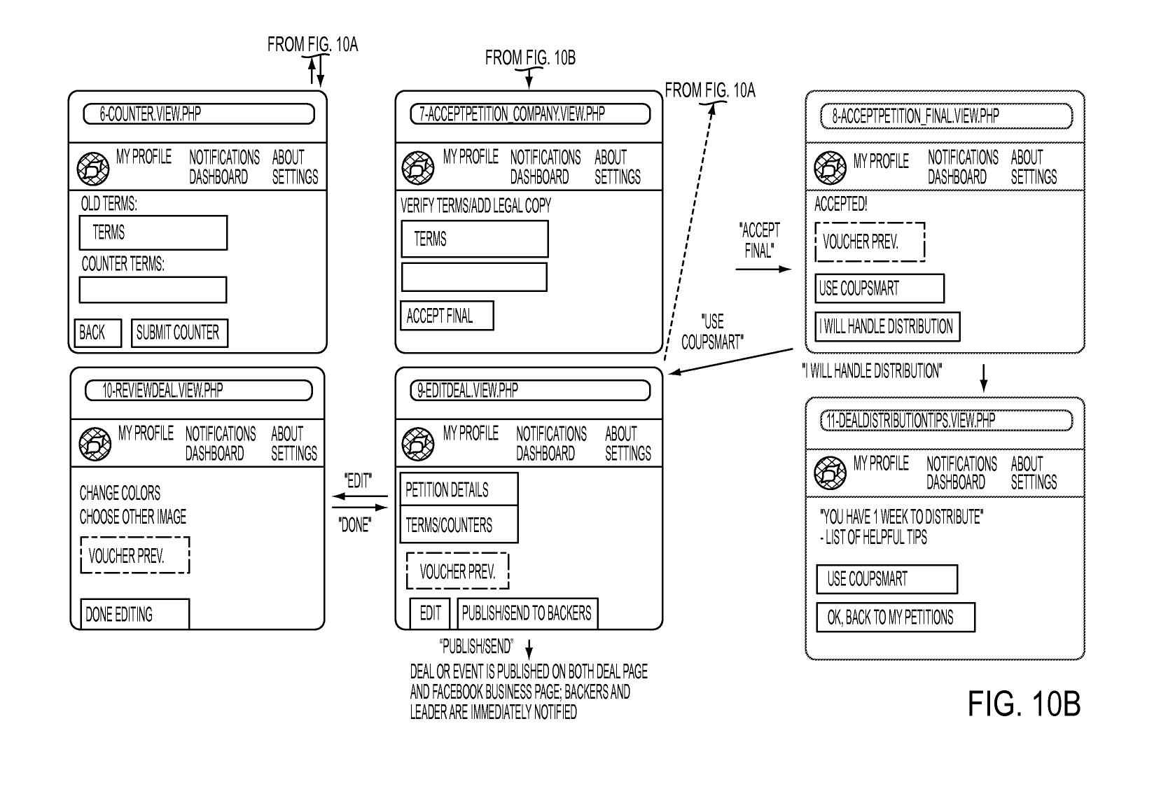

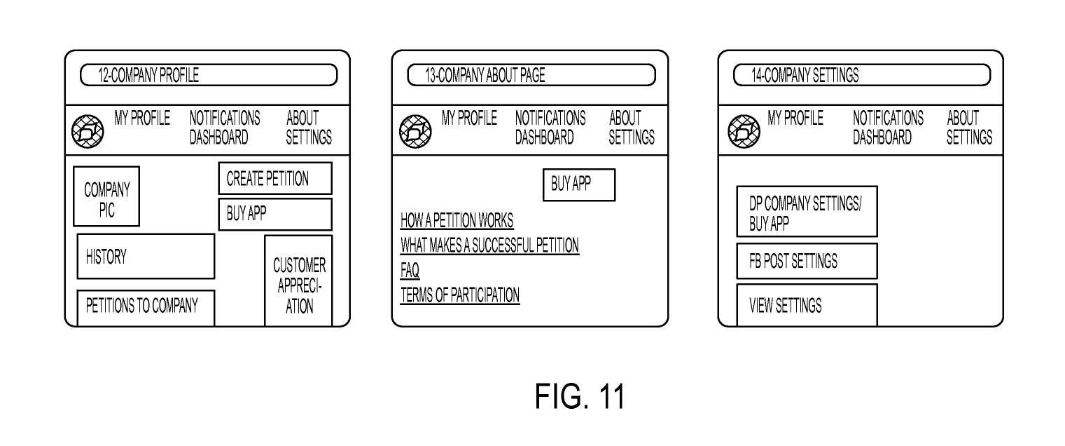

Referring now to FIGS. 10 and 11, example company specific modules for illustrating functions associated with the user interfaces is provided. Similar to the user specific modules, in the company specific modules, in a first embodiment a user associated with a company (hereinafter referred to as the company, the user, or the user associated with the company as appropriate for the context) can execute an application such as a browser and enter, or select, a URL to access the system. In a second embodiment, the user can execute a social network application, for example by accessing a social network website such as Facebook™ using a browser, or through a dedicated application, for example an app on a mobile computing device.

In the module labeled 1, the user enters the site via URL, and is introduced to the site on the landing page. The user is presented with an explanation of the Deal Petition (DP) process with three simple illustrated steps and a link below inviting them to get started. In addition, links are provided for users not associated with companies (for routing the user to a user connect page) and bloggers. In module 2, if a company clicks on the “get started” link, the company can be asked to log in via a social media website, such as Facebook™, and accept Deal Petition permissions. The user can be directed to a page showing petitions associated with the company on a limited dashboard page. Full dashboard access can be made available when a company logs in to the DP site via a social media website. The company can opt out of doing this, but generally the company logs in to take actions on any petition. The company dashboard can be the hub for all Deal Petition activity and organization of petitions. Companies can filter petitions by “trending”, or view only the petitions that the company is associated with by selecting “mine” (default selection). Each petition listed on the dashboard can display a variety of information including the parties involved, the petition name, the details of the promotion, the number of current supports, the minimum and maximum number of supporters required, petition status, and available awards. Links to “view” or to “reject”, “accept”, “acknowledge”, or “counter” a petition (depending on the petition's status) can also be provided per petition. The company can click “reject”, “accept”, “acknowledge”, or “counter” on the petition on the dashboard view. In a configuration, clicking these actions with direct the user to the petition page. Essentially, “rejecting”, “accepting”, “acknowledging”, or “countering” a petition has the same effect as clicking “view” on a petition. In a configuration, the company can be a decision regarding a petition on the “global petition page.”

In module 3, a global petition page for a petition is an accessible page with a unique link that is viewable by all members of Deal Petition. If the petition is for an event, the petition page may be exclusive to a certain group of intended event attendees. Petition pages can show relevant information related to a petition dependent on that petition's stage and the account status of the viewer (in this example, the status is “company”). If a company is entering from a social media website (for example, using a company version of the app, or by linking through a notification received on a social media website, the user can be directed to the global petition page, as the company will have already agreed on Deal Petition permissions. The company can make decisions to “reject”, “accept”, “acknowledge”, or “counter” the petition on the petition page using a designated link. A newly created petition page can have limited functionality. A company can view the page if the petition is still trying to collect the minimum number of supporters. When the petition becomes supported by the minimum amount of users or consumers, the petition becomes a “filled petition”. The company can choose to accept the petition at any time, or the company can accept once the petition has reached its minimum number of supporters. All supporters can be notified by default when the minimum number is reached, and the petition shows up as a post or notification on a company's page on a social media website. As a petitioned company, the company can manage petition-related decisions from the global page. All parties affiliated with the petition can invite supporters or publish comments from the petition page. Supporters of the petition and companies affiliated with this petition can be notified when a petition has been edited by the petition leader. Counter offers made by a company or a user can be viewed on the petition page under the original terms. A company can offer a counter offer to the original terms, a counter offer to another counter, or choose to accept the petition's original terms or user's counter offer terms (in which case the petition's supporters can receive a notification). A user who creates the petition and a company being petitioned may go back and forth on petition terms for as many rounds as necessary. All affiliated supporters can be viewed in a section located near the terms section. A company's global petition page can present support data that can be more detailed and rich, displaying name, location, age, likes/dislikes, relationship status, etc. If the petition is an event, the company can also choose to view the event page on a social media website.

In module 4, to reject a petition, the company can be directed to the “company reject petition” page, which prompts the user associated with the company to verify that the user wants to delete that particular petition. The user can choose to return to the petition's global page, or select “yes, I am sure” to delete the petition. The petition leader and supports will be notified that the petition has been rejected.

In module 5, upon rejecting a petition, the company is directed to a delete confirmation page, which also contains an option to “thank petition supports.” A link can provide a window for sending a message the petition leader and supporters using social networking or through the Deal Petition interfaces. The company can offer a thank you or special deal for the efforts of the petitioner and supporters, and can play an important role in the company's customer service reputation and soften the impact of the rejected petition with consumers.

In module 6, a company can “counter offer” the current petition's terms, and be directed to a “company counter terms” page. The user associated with company can review the current terms on the page and make edits to the terms in the petition. The company can “submits” the new terms, and the terms can appear under the “terms and counters” section on the global petition page. The petition leader and supporters can be notified of the counter terms offer.

In module 7, a company can elect to “accept” the current terms. The company can be directed to the “company accept petition #1” page. The petitioner and supporters can be notified that the petition is about to be accepted. After the initial acceptance, the system can be configured to provide the company with a short period in which to verify the terms and add any restrictions or legal copy. In a configuration, the actual terms of the petition are not editable, and negating any of the final petition terms can be strongly discouraged. Once the company has clearly outlined the legal copy and restrictions, the user association with the company can selectively activate the final “accept” button. The petitioner and supporters can be notified that the petition has been accepted. The company can have several days, for example seven days, in which to distribute the deal or create the event.

In module 8, if a company officially accepts a petition, the company is directed to the “company accept petition final” page. If the petition relates to a product, a promotion can be automatically generated. For example, a CoupSmart-generated smart deal can be created and distributed for the company. The company can also select to handle the distribution by activating the “I will handle distribution” link. If the petition relates to an “event” a page can outline the terms for creating the event and distributing the deal at the event.

In module 9, if a company elects to use the “Use CoupSmart” link, the company can be directed to the “company CoupSmart deal” page. The “company CoupSmart deal” page can use the CoupSmart Smart Deal Designer software to generate a deal or promotion preview in order to post the Smart Deal to the company's page on a social media website. All relevant info can be provided. The company can change the appearance of the deal or promotion by selecting the “edit” link, which can be located at the bottom of the page. Once the company is satisfied with the deal's appearance, the user representing the company can select the “publish/send to supporters” button, and the deal appears on users' pages associated with the supports. The petition leader and supporters can be notified that their deal or promotion is available.

In module 10, if a company elects to edit the deal or promotion associated with the terms of the petition, then the company can be directed to a page that allows the company change the appearance of their deal or promotion including design and images. When the user representing the company is finished, the user can select the “done editing” button and return to the “company CoupSmart deal” page to view the edited, updated deal voucher or promotion.

In module 11, if a company elects to handle distribution of the deal or promotion, the company can be directed to a page with terms and tips on how to distribute a deal or promotion. In a configuration, a “Use CoupSmart” option can be found on the page in the event the company decides to use the CoupSmart server. The user associated with the company can select an “ok” button to accept the terms of distribution, and can be directed back to the dashboard list of the company's petitions.

In module 12, the company can be directed from the company's global navigation, to the company profile page by selecting the “my profile” link. In a configuration, the company can be limited to accessing the global navigation screen only when logging in through a social networking website, such as Facebook™. On the company profile page, a company can view the company's “user” picture, profile information and stats, petition history, and active petitions associated with the company. In various configurations, the company can elect to create a petition, purchase the Deal Petition app for their company Facebook page, and reward users with a “customer appreciation” acknowledgement.

In module 13, by selecting the “about” link on company's global navigation page, the company can be directed to a company “about” page, for example to review information about how to use Deal Petition as a company. The company can also select links that can inform a user about how petitions work, FAQs, and terms of participation.

In module 14, a “company settings” page allows a company to configure page settings, social media website post settings, and Deal Petition settings. The page can include a “buy app” link for a company to purchase the Deal Petition app for their Facebook page.

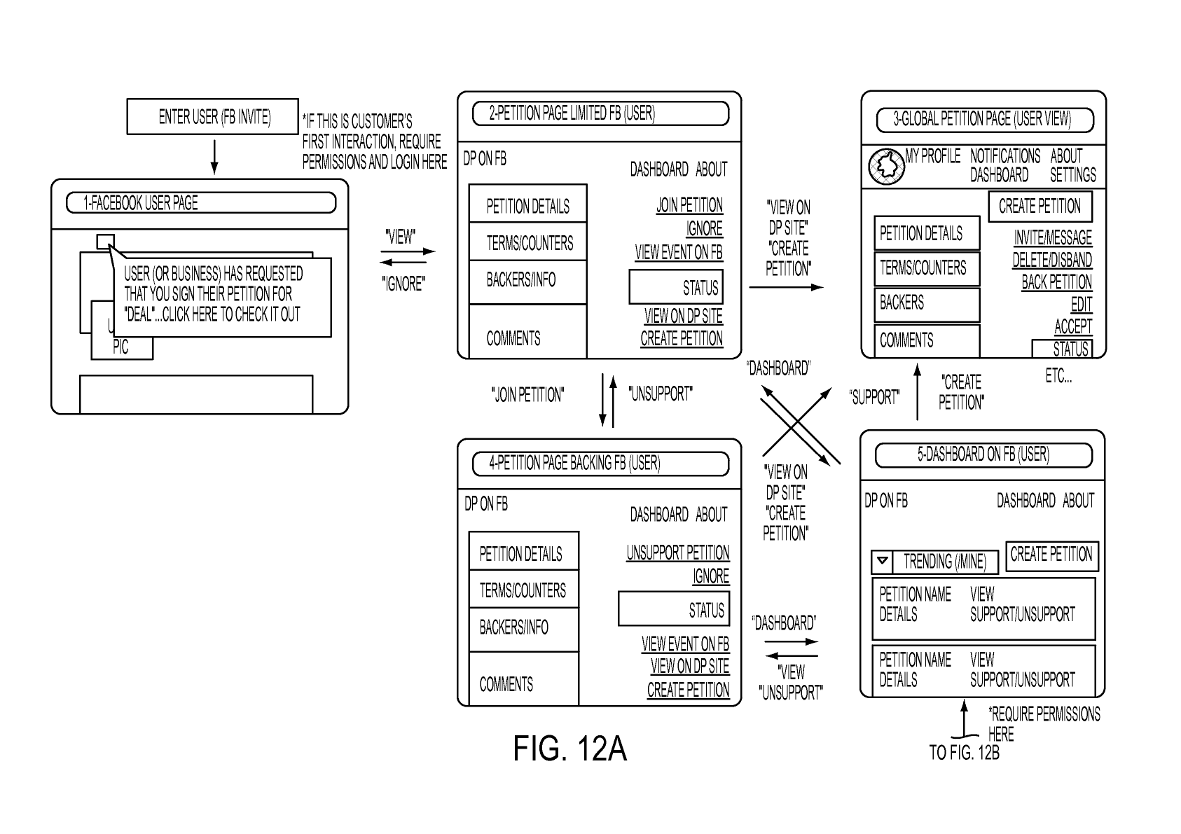

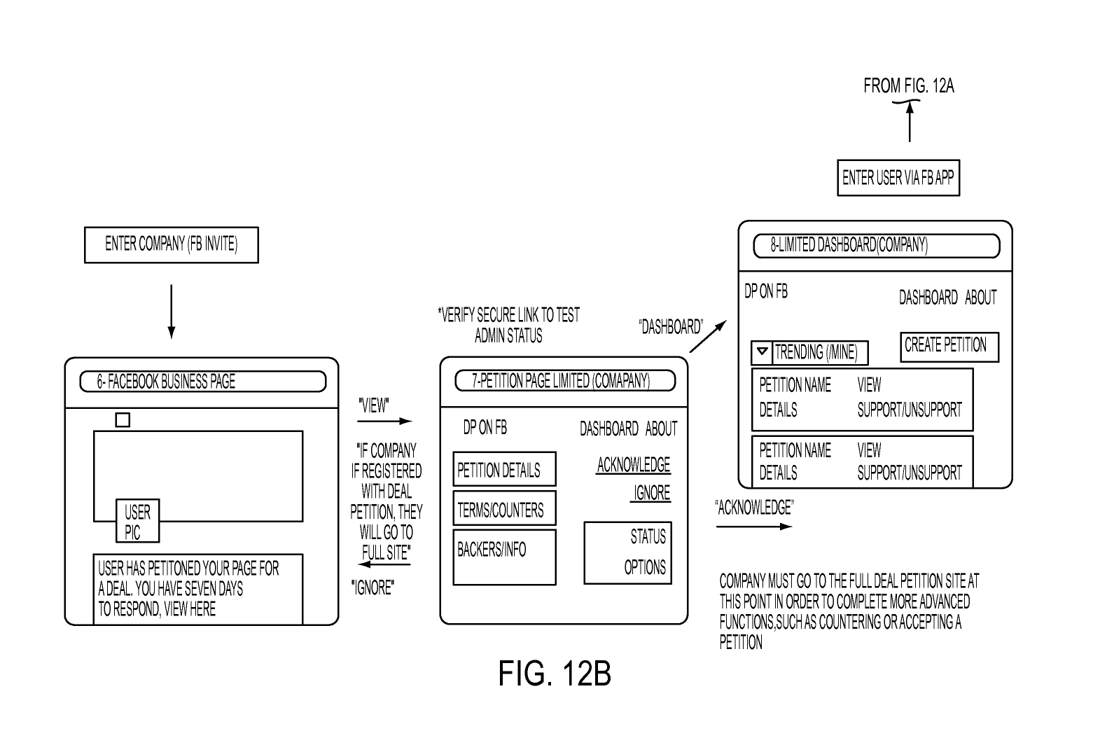

Referring now to FIG. 12, example modules for illustrating functions associated with the social networking interfaces is provided. The user, or a user associated with a company can execute a social network application, for example by accessing a social network website, such as Facebook™, using a browser, or through a dedicated application, for example an app on a mobile computing device. In a configuration, the system can be limited in functionality when using a social networking app. For example, through a social networking app the users can view, support, and unsupport petitions. However, to create and manage a petition, a user can be required to use a URL and navigate to a full featured system on a website outside of the social networking website. One purpose of an app can be to introduce a new user to a limited number of functions with an easy to use interface, for example in order to familiarize the user to the features and encourage the users to use the full featured system on the website at a later time.

In a first embodiment, the limited interfaces associated with a social network application relate to user functions. In module 1, if a user logs on using a social network website, the user can receive a notification from the Deal Petition app that they have been invited to join or support another user's petition. The notification can include the name of the person or consumer who invited the user, the number of petition supporters, and the petition's title or name. By clicking on a link in the notification, the user can be directed to the limited petition page within the Deal Petition app.

In module 2, a user can be required give permissions to the Deal Petition app prior to be directed to the limited petition page within the app. On the limited petition page, a user can view the petition, the petition's details, petition status, supporters, comments, and so forth. If the petition is for an event, the user can choose to view the event page using a social media app. The user can “join” the petition as a supporter. The user can also “view the petition on the Deal Petition site”, and “create” a petition. On the limited app deal page, the user can also view an “about” page on the global navigation within the Deal Petition app to view information about the user.

In module 3, a user can select “create petition” or “view on Deal Petition Site” within the app's petition page (or dashboard page) to navigate to the petition's global petition page on the Deal Petition site.

In module 4, a user can select “join petition” from the app's limited petition page to become a support of the petition. The app's limited petition page can reflect the user's change in status, and the user can elect to leave comments on the petition page. The user can also select “unsupport” to stop supporting a petition, and the user can be directed back to the app's limited petition page.

In module 5, a user can select “dashboard” from the global navigation within the app, and the user can be directed to a limited dashboard within the Deal Petition app. In the limited dashboard, the user can view petitions that the user supports, or petitions that are currently trending. Trending generally is an indication that support for a petition is changing dynamically at a rate greater than other petitions. A user can choose to “view” or “support” or “unsupport” a petition, and the user can be directed to the petition's page within the app. The user can select a “create petition” link, and the user can be directed to a petition creator app on the Deal Petition website.

Still referring to FIG. 12, in a second embodiment, the limited interfaces associated with a social network application relate to company functions. Because a company's interactions with Deal Petition can involve taking direct action on petitions, the company can be limited to basic pages within the Deal Petition app before being routed to the Deal Petition site.

In module 6, a company can log onto a social network app and receive a notification from the Deal Petition app that a petition associate with the company has reached a threshold number of supporters, and is now “filled”. Generally this occurs some period of time after the petition was created and began collecting supporters. If the company previously receive notice of the petition, and the company has connected the company Deal Petition account to a social media app, then selecting a link associated with the notification can direct the company to the global deal page on the Deal Petition site. If the company had not yet viewed the petition, or interactive with the Deal Petition site, the company can select “view” in the notification to review the details of the petition in the Deal Petition social networking app.

In module 7, a company can be directed to a “limited petition page” in the app and the company take an action after viewing the petition details. The company can select the “acknowledge” button and be directed to the global petition page on the Deal Petition site. Selecting the “acknowledge” button can notify the petitioner and supporters that the company may be interested in the petition. After selecting “acknowledge”, the company can be prompted to enter the email address of the person in charge of approving petitions. The company can also select the “ignore” button. Selecting the “ignore” button can notify the petitioner and supporters that the company is not interested in a petition. In a configuration, selecting the “ignore” button can cause the petition to be deleted. The company can be presented an option to send a message the petitioner supporters, for example to thank them or to offer another deal. The company can also take no action, and after seven days, the deal will be considered “ignored” by the system.

In module 8, a limited company dashboard in the social media app can show a list of company-related petitions and trending petitions. A petition can be “viewed” within the app. Additional actions can be selected, including “view analytics”, that direct the company to the full Deal Petition site.

These and other embodiments of the systems and methods for petitioning for promotions from companies using social networks can be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

What is claimed is:

1. A computer-based method, comprising:
generating, by a first user, a petition that includes a request for a promotional offer from a company;
inviting, by the first user, a second user to join the petition;
joining, by the second user, the petition; and
offering, by the company, the promotional offer in response to the petition,
wherein the promotional offer is offered by social media, and
wherein the determination to offer the promotional offer is based at least in part on the second user joining the petition.

2. The computer-based method of claim 1, further comprising:
inviting, by the first user, a plurality of users to join the petition, and
wherein the determination to offer the promotional offer is based at least in part on a threshold number of users joining the petition

3. A computer-based method, comprising:
generating, by a user of a social media website, a petition that includes a request for a promotional offer from a company;
posting, by the user, the petition using the social media website;
joining, by a plurality of users of the social media website, the petition using the social media website; and
offering, by the company, the promotional offer using social media,
wherein the company offers the promotional offer at least in part on the number of users joining the petition using the social media website.

4. The computer-based method of claim 3, wherein the terms of the promotional offer are based at least in part on the number of users joining the petition.
